(19) United States
(12) Patent Application Publication
(10) Pub. No.: US 2024/0367380 A1
(43) Pub. Date: Nov. 7, 2024

(54) LATTICE STRUCTURES WITH CONFORMAL AND TRIMMED LATTICE CELLS

(71) Applicant: Hewlett-Packard Development Company, L.P., Spring, TX (US)

(72) Inventors: James Andrew MCCUTCHEON, Vancouver, WA (US); Brent Charles EWALD, Vancouver, WA (US); Geoffrey Franklin SCHMID, San Diego, CA (US)

(21) Appl. No.: 18/292,866

(22) PCT Filed: Jul. 29, 2021
(86) PCT No.: PCT/US2021/071045

§ 371 Date: Jan. 26, 2024

(51) Int. Cl. B29C 64/386; A43B 13/18; B29K 21/00; B29K 75/00; B29L 31/50; B33Y 50/00; B33Y 80/00

(52) U.S. Cl. CPC B29C 64/386; A43B 13/181; B33Y 50/00; B33Y 80/00; B29K 2021/003; B29K 2075/00; B29L 2031/504

(57) ABSTRACT

In some examples, an object manufactured by an additive manufacturing process includes a lattice structure having a first region filled with conformal lattice cells of different characteristics, and a second region filled with uniform lattice cells some of which are trimmed.

### BACKGROUND

An additive manufacturing machine can be used to form a lattice structure. In some examples, a compressible layer used in consumer and sporting goods, in vehicles, and so forth, can have a lattice structure. In other examples, other products can include lattice structures.

Additive manufacturing machines produce three-dimensional (3D) objects by accumulating layers of build material, including a layer-by-layer accumulation and solidification of the build material patterned from computer aided design (CAD) models or other digital representations of physical 3D objects to be formed. A type of an additive manufacturing machine is referred to as a 3D printing system. Each layer of the build material is patterned into a corresponding part (or parts) of the 3D object.

### BRIEF DESCRIPTION OF THE DRAWINGS

Some implementations of the present disclosure are described with respect to the following figures:

FIG. 1 illustrates an object including a lattice structure with conformal and trimmed lattice cells, according to some examples;

FIGS. 2A-2D are block diagrams of lattice cells according to some examples;

FIG. 3 is a perspective view of surfaces of an upper and an outsole, which define a volume into which conformal and trimmed lattice cells are to fill, in accordance with some examples;

FIG. 4 is a side view of surfaces of an upper and an outsole, which define a volume into which conformal and trimmed lattice cells are to fill, in accordance with some examples;

FIG. 5 is a perspective view of a mid-surface defined between surfaces of an upper and an outsole, according to some examples;

FIG. 6 is a flow diagram of a process of a hybrid lattice structure generation engine, according to some examples;

FIG. 7 is a block diagram of a storage medium storing machine-readable instructions, according to some examples;

FIG. 8 is a flow diagram of a process of creating a hybrid lattice structure, according to some examples.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION

In the present disclosure, use of the term “a,” “an,” or “the” is intended to include the plural forms as well, unless the context clearly indicates otherwise. Also, the term “includes,” “including,” “comprises,” “comprising,” “have,” or “having” when used in this disclosure specifies the presence of the stated elements, but do not preclude the presence or addition of other elements.

A lattice structure refers to a physical structure having an interlaced pattern of connecting members that are interconnected with one another. The connecting members can be referred to as “beams.” A beam can refer to a generally elongated member within the lattice structure. The beam can be straight, can be curved, or can have a more complex shape than merely being straight or curved. A lattice structure can include an arrangement of unit cells, where the unit cells are repeated and interconnected to one another to define a lattice. A “unit cell” of a lattice structure includes an arrangement of beams.

In the ensuing discussion, a “unit cell” of a lattice structure is referred to as a “lattice cell.” A lattice cell is repeated to provide multiple instances of the lattice cell that are then interconnected to represent a 3D object that is to be built.

An additive manufacturing machine can be used to build a lattice structure that includes a repeating or periodic arrangement of lattice cells. A digital representation (e.g., a CAD file) of a 3D object to be built is provided to the additive manufacturing machine to allow the additive manufacturing to build the 3D object on a layer-by-layer basis. The digital representation of a target 3D object that includes a lattice structure includes an arrangement of the lattice cells that make up the lattice structure. The digital representation specifies an interconnection of the lattice cells to form the target 3D object. The additive manufacturing machine builds the arrangement of lattice cells on a layer-by-layer basis.

Building a lattice structure with an additive manufacturing machine can allow for better control of mechanical characteristics of the lattice structure than possible with other manufacturing techniques. For example, a digital representation of the lattice structure can be adjusted to change mechanical properties (e.g., compressibility, stiffness, density, mechanical strength, kinetic energy dissipation, kinetic energy return, deceleration, etc.) of the lattice structure.

In some examples, a lattice structure is compressible based on the material used to form the lattice structure, where the material can include a thermoplastic polyurethane material or another elastomeric material. In other examples, materials used to form lattice structures can include a metal, a plastic, and so forth. In further examples, a lattice structure can exhibit other types of deformations, such as bending, pivoting, and so forth.

A lattice structure can be defined by use of a CAD tool or another program executed in a computer system when creating a digital representation of a 3D object to be built.

There are two general approaches to forming a lattice structure containing lattice cells to achieve a target shape. In some cases, the target shape of the lattice structure may be complex. As used here, a “complex” shape can refer to a shape defined by irregular surfaces, such as surfaces that change directions multiple times or have a curve or multiple different curves.

An example of a physical object having a complex shape is a midsole of a shoe. A shoe can include various layers. The layers include an outsole (the exposed part of the shoe that is in contact with the ground), an upper (the part of the shoe that is in contact with the wearer's foot), and a midsole (the layer between the outsole and the upper). The sole can have different curves to conform to the wearer's foot. Additionally, a midsole is shaped to conform with the outsole and the upper.

Although reference is made to examples of forming lattice structures for a midsole of a shoe, it is noted that other examples, techniques or mechanisms according to some implementations of the present disclosure can be used to form lattice structures for other objects, such as helmets, seat cushions, or any other type of object or cushioning element.

The two general approaches to forming a lattice structure can include a first approach that uses uniform lattice cells that are subject to trimming, and a second approach that uses conformal lattice cells.

The first approach involves repeating uniform lattice cells and interconnecting the repeated lattice cells to form a lattice structure. “Uniform” lattice cells can refer to lattice cells that have a common characteristic, including any or some combination of the following: a common size, a common shape, and a common orientation.

To fit the lattice structure including the uniform lattice cells to a target shape, the lattice structure can be trimmed by cutting certain lattice cells at external surfaces of the lattice structure. The “external” surfaces of the lattice structure can refer to surfaces that are exposed to an environment around the lattice structure.

Trimming lattice cells (where the trimming is done digitally using a program such as a CAD tool or another program) on the external surfaces of the lattice structure can remove or shorten beams of the trimmed lattice cells. The trimmed lattice cells on the external surfaces of the trimmed lattice structure may have an incomplete arrangement of beams (i.e., a beam or beams of lattice cells can be removed or cut short). Trimming lattice cells can change a property of the trimmed lattice cells (as compared to untrimmed lattice cells). For example, trimming a lattice cell can change a mechanical strength of the trimmed lattice cell, change a compressibility of the trimmed lattice cell, change a smoothness of a surface defined by the trimmed lattice cell, and so forth. As a result, an object formed with a lattice structure that has trimmed lattice cells may have certain portions that lack a target mechanical strength, has reduced compressibility, has reduced smoothness, and so forth. More generally, an object formed with a lattice structure that has trimmed lattice cells may have a property that deviates from a target value or a target range of values.

The second approach to filling a lattice structure with lattice cells involves the use of conformal lattice cells. A conformal lattice cell refers to a lattice cell that can have a shape, size, and/or orientation that can be different from another conformal lattice cell in the lattice structure. More generally, a conformal lattice cell can be deformed when building a lattice structure. The deforming of conformal lattice cells is accomplished digitally using a program.

The shape or size of a conformal lattice cell can be changed by warping or scaling the conformal lattice cell. Warping a conformal lattice cell refers to changing the shape of one portion of the conformal lattice cell relative to another portion of the conformal lattice cell, such as by squeezing one part of the conformal lattice cell while another part is not squeezed. Scaling a conformal lattice cell can refer to increasing or reducing the size of the conformal lattice cell so that the conformal lattice cell becomes larger or smaller relative to the conformal lattice cell prior to scaling. Note that scaling can be performed in one dimension or in multiple dimensions. Scaling of a conformal lattice cell in less than three dimensions in the X-Y-Z coordinate space may result in an aspect ratio of the conformal lattice cell being changed (e.g., the ratio of the length and width of the conformal lattice cell is changed).

The orientation of a conformal lattice cell can be changed in a lattice structure by rotating the conformal lattice cell so that an axis of the conformal lattice cell is changed from extending along a first direction to extending along a different second direction.

In a lattice structure including conformal lattice cells, each of the conformal lattice cells has an overall arrangement of beams that is generally the same. However, the arrangement of beams of each conformal lattice cell can be deformed to fit within a volume of the lattice structure.

Generally, in a lattice structure with conformal lattice cells, a first lattice cell may have a characteristic that is different from a second lattice cell. For example, the first lattice cell may have a size (e.g., overall size or aspect ratio) that is different from the second lattice cell, and/or the first lattice cell may have a shape that is different from the second lattice cell, and/or the first lattice cell may have an orientation that is different from the second lattice cell, and so forth. More generally, the first lattice cell may have a value of a characteristic that is different from a value of the characteristic of the second lattice cell.

Forming a lattice structure using conformal lattice cells avoids having to trim certain lattice cells to fit within a given volume. However, the use of conformal lattice cells can lead to other issues. For example, the use of conformal lattice cells can result in dense regions of conformal lattice cells, such as in regions of the lattice structure with smaller features than in other regions of the lattice structure. The dense regions of conformal lattice cells can include conformal lattice cells deformed to fit into a relatively small sub-volume of the lattice structure, which can result in properties of lattice cells in these dense regions deviating from a target value or range of values. For example, within a small sub-volume, conformal lattice cells may be scaled and/or warped significantly to fit within the small sub-volume. In some examples, a portion of a lattice structure having a dense arrangement of conformal lattice cells can exhibit an increased stiffness, reduced compressibility, and so forth. Moreover, a dense region of conformal lattice cells can be more difficult to manufacture using an additive manufacturing machine, since some of the lattice cells may be so small that the additive manufacturing machine cannot accurately reproduce the dense arrangement of conformal lattice cells.

In accordance with some implementations of the present disclosure, hybrid lattice structure forming techniques or mechanisms are used to produce a lattice structure that uses both the first approach and second approach noted above. The hybrid lattice structure forming techniques or mechanisms can use both conformal lattice cells and uniform lattice cells that are subject to trimming.

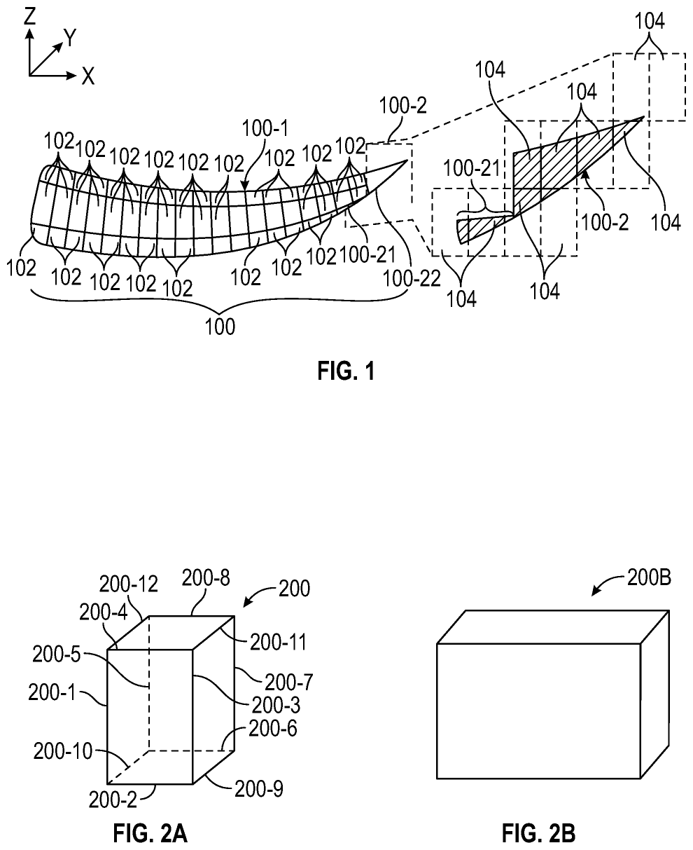

FIG. 1 illustrates a representation of a hybrid lattice structure 100, in accordance with some implementations of the present disclosure. The representation of the hybrid lattice structure 100 is a digital representation, such as a CAD file or other file produced using a CAD tool or other program, for example. Note that techniques or mechanisms according to some implementations of the present disclosure are applicable to other example hybrid lattice structures different from the hybrid lattice structure 100.

In accordance with some implementations of the present disclosure, the hybrid lattice structure 100 includes a first hybrid lattice structure portion 100-1 and a second hybrid lattice structure portion 100-2. The first hybrid lattice structure portion 100-1 includes conformal lattice cells 102. As seen in FIG. 1, the conformal lattice cells in the first hybrid lattice structure portion 100-1 can have different characteristics, such as different sizes, shapes, and/or orientations.

The second hybrid lattice structure portion 100-2 includes uniform lattice cells 104 a collection of which are to be trimmed. In the second hybrid lattice structure portion 100-2, the collection of uniform lattice cells to be trimmed can include all of the uniform lattice cells in the second hybrid lattice structure portion 100-2 or a subset (less than all) of the uniform lattice cells in the second hybrid lattice structure portion 100-2.

The dotted outlines of the uniform lattice cells 104 in the second hybrid lattice structure portion 100-2 represent the portions of the uniform lattice cells 104 that have been trimmed. The shaded portions of the uniform lattice cells 104 are the portions of the uniform lattice cells 104 that have not been trimmed.

In other examples, the hybrid lattice structure 100 can include multiple first hybrid lattice structure portions 100-2 with conformal lattice cells and/or multiple second hybrid lattice structure portions 100-2 with uniform lattice cells a collection of which are to be trimmed.

In some cases, the first hybrid lattice structure portion 100-1 and the second hybrid lattice structure portion 100-2 can be next to each other, such as along the X axis shown in FIG. 1 of the hybrid lattice structure 100. In other examples, the first hybrid lattice structure portion 100-1 and the second hybrid lattice structure portion 100-2 may be one over another such as along the Z axis shown in FIG. 1.

In the example of FIG. 1, a first sub-segment 100-21 of the second hybrid lattice structure portion 100-2 is underneath a layer of conformal lattice cells 102 along the Z axis (e.g., the layer of conformal lattice cells 102 is on top of the first sub-segment 100-21). Also, a second sub-segment 100-22 of the second hybrid lattice structure portion 100-2 is next to conformal lattice cells in the first hybrid lattice structure portion 100-1 along the X axis.

The hybrid lattice structure 100 also extends in a third dimension, along the Y axis of FIG. 1. Thus, the hybrid arrangement of conformal lattice cells and uniform lattice cells that are subject to trimming can extend in three dimensions (X, Y, and Z in the example of FIG. 1).

In the example of FIG. 1, there are three layers of conformal lattice cells 102 in the first hybrid lattice structure portion 100-1 including a top layer, a middle layer, and a bottom layer. In the example of FIG. 1, a portion of the second layer of conformal lattice cells 102 is on top of the first sub-segment 100-21, which includes a layer of trimmed uniform lattice cells 104.

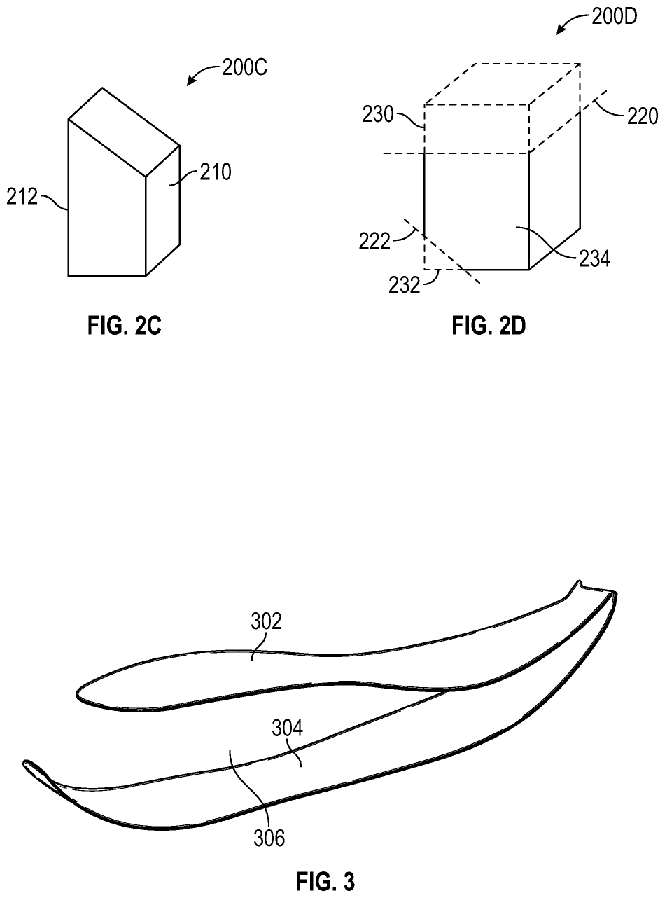

FIG. 2A depicts an example lattice cell 200 that is generally in the shape of a rectangular cuboid. The lattice cell 200 has beams 200-1, 200-2, 200-3, 200-4, 200-5, 200-6, 200-7, 200-8, 200-9, 200-10, 200-11, and 200-12 that are interconnected to form the rectangular cuboid. In other examples, a lattice cell can have a different arrangement of beams. For example, a lattice cell may include an inner core to which beams are connected. If the lattice cell 200 is a conformal lattice cell, then a characteristic of the lattice cell 200 can be changed, such as by scaling the lattice cell 200, warping the lattice cell 200, or re-orienting the lattice cell 200.

FIG. 2B shows an example of a scaled lattice cell 200B, in which the width of the lattice cell 200 from FIG. 2A has been stretched to form the scaled lattice cell 200B that is wider than the lattice cell 200. The height of the scaled lattice cell 200B is the same as the lattice cell 200, so that an aspect ratio of the scaled lattice cell 200B is different from the aspect ratio of the lattice cell 200.

A warped lattice cell 200C is shown in FIG. 2C, in which the right side 210 of the warped lattice cell 200C has been reduced in height relative to the left side of the warped lattice cell 200C.

In other examples, other deformations of the lattice cell 200 of FIG. 2A can be applied.

In examples where the lattice cell 200 of FIG. 2A is not a conformable lattice cell, then the lattice cell 200 can be subject to trimming. FIG. 2D shows an example of a trimmed lattice cell 200D that has been cut at line segments 220 and 222. Portions of the trimmed lattice cell 200D shown in dotted profile represent the trimmed portions 230 and 232. The portion 234 of the trimmed lattice cell 200 is the portion remaining after the cutting at 220 and 222.

In some examples, the lattice structure 100 depicted in FIG. 1 is for forming a midsole of a sole in a shoe. In other examples, a first portion of the midsole includes a lattice structure, while a second portion of the midsole does not include a lattice structure. The midsole is located between and an upper that is over the midsole, and an outsole that is below the midsole. The outsole are also part of the sole of the shoe.

In other examples, the lattice structure 100 can be used to form other structures, such as a cushion in a helmet or a seat. The midsole is an example of a cushion in a shoe.

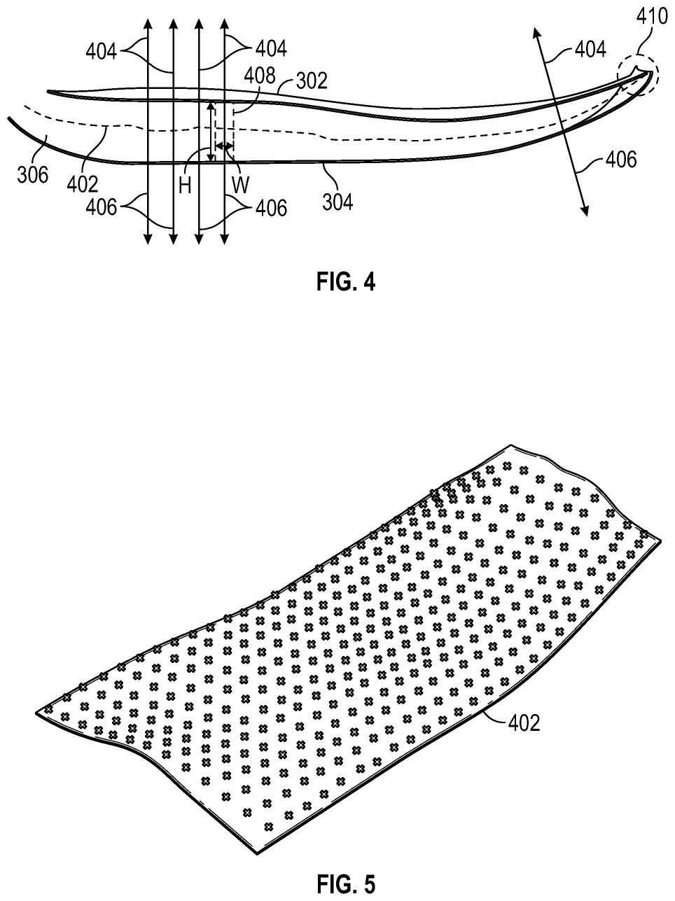

FIG. 3 is a perspective view of a bottom surface 302 of the upper (or more generally, a shoe layer that is above a midsole), an upper surface 304 of the outsole (or more generally, a shoe layer that is below the midsole), and a volume 306 between the surfaces 302 and 304. FIG. 4 is a side view of the surface 302 of the upper, the surface 304 of the outsole, and the volume 306 between the surfaces 302 and 304. The midsole is to be created in a volume 306 between the surface 302 of the upper and the surface 304 of the outsole. FIG. 4 also shows a mid-surface 402 (also shown in FIG. 5), which is discussed further below.

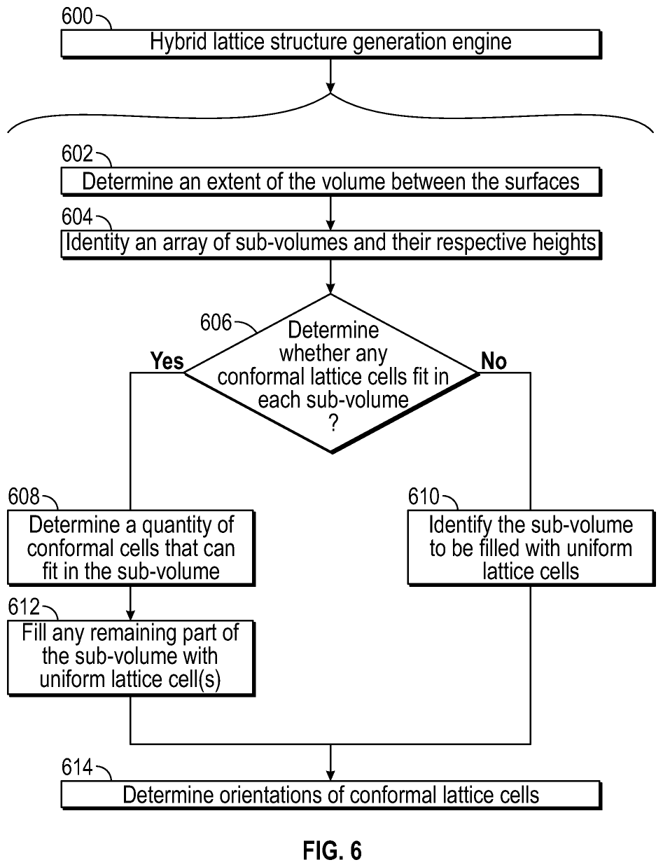

In accordance with some implementations of the present disclosure, as shown in FIG. 6, a hybrid lattice structure generation engine 600 performs a process to generate a hybrid lattice structure for the midsole that is to fit in the volume 306.

As used here, an “engine” can refer to a hardware processing circuit, which can include any or some combination of a microprocessor, a core of a multi-core microprocessor, a microcontroller, a programmable integrated circuit, a programmable gate array, or another hardware processing circuit. Alternatively, an “engine” can refer to a combination of a hardware processing circuit and machine-readable instructions (software and/or firmware) executable on the hardware processing circuit.

The hybrid lattice structure generation engine 600 identifies a first region of the volume 306 in which conformal lattice cells are to be used, and a second region of the volume 306 in which uniform lattice cells subject to trimming are to be used. Although reference is made to “region” in the singular sense, note that the first region or the second region can in some examples be made up of multiple sub-regions.

To identify the first and second regions for the conformal lattice cells and uniform lattice cells, respectively, the hybrid lattice structure generation engine 600 determines (at 602) an extent (dimensions) of the volume 306 between the surface 302 of the upper and the surface 304 of the outsole.

The following discusses an example of determining the dimensions of the volume 306 into which lattice cells of a lattice structure are to fit. In other examples, other techniques of determining dimensions of the volume 306 can be employed.

In accordance with some examples of the present disclosure, the hybrid lattice structure generation engine 600 identifies the mid-surface 402 (FIG. 4) between the surface 302 of the upper and the surface 304 of the outsole. The mid-surface 402 surface extends generally along the length of the volume 306.

A perspective view of an example of the mid-surface 402 is shown in FIG. 5. Each point along the mid-surface 402 intersects a mid-point between the surface 302 of the upper and the surface 304 of the outsole. A “mid-point” between the surfaces 302 and 304 is a point at the center of the gap between the surfaces 302 and 304 at any given position along the length of the volume 306.

In some examples, the hybrid lattice structure generation engine 600 creates a grid that lies on the mid-surface 402, where the grid is a network of intersecting parallel lines extending along the mid-surface 402. Intersection points of the network of intersecting parallel lines are represented by “x” in FIG. 5. The network of intersecting parallel lines form rectangles on the mid-surface 402, where each rectangle defines an area where a lattice cell is to be placed.

The hybrid lattice structure generation engine 600 can create rays 404 (see, e.g., FIG. 4) that project upwardly from the “x” points of the mid-surface 402, and can create rays 406 that project downwardly from the “x” points of the mid-surface 402. Each ray 404 or 406 is perpendicular to the respective “x” point at which the ray 404 or 406 intersects the mid-surface 402.

The projected rays 404 intersect the surface 302 of the upper, and the projected rays 406 intersect the surface 304 of the outsole, as shown in FIG. 4. Based on the intersections of the rays 404 and 406 with the respective surfaces 302 and 304, the hybrid lattice structure generation engine 600 is able to determine a first distance between the mid-surface 402 and the surface 302, and a second distance between the mid-surface 402 and the surface 304. The first distance and the second distance together define a height of the volume 306 between the surfaces 302 and 304 at each “x” point on the mid-surface 402.

FIG. 4 shows an example of a sub-volume 408 that extends from the surface 304 to the surface 302. The sub-volume 408 has a height H derived by the hybrid lattice structure generation engine 600 based on the above process. The sub-volume 408 also has a width W that is a width of a lattice cell. The width is defined between two adjacent “x” points on the mid-surface 402, for example. Although not visible in FIG. 4, the sub-volume 408 would also have a depth that is a depth of the lattice cell.

The hybrid lattice structure generation engine 600 is able to identify (at 604) an array of sub-volumes 408 and their respective heights H. The array of sub-volumes 408 coincide with the rectangles identified by the grid formed on the mid-surface 402, for example. In other words, each sub-volume 408 has the width and depth of the rectangle defined by four adjacent “x” points on the grid on the mid-surface 402.

Based on the height H of each sub-volume 408, the hybrid lattice structure generation engine 600 determines (at 606) whether any conformal lattice cells can fit in the sub-volume 408, and if so, how many layers of conformal lattice cells can fit in the sub-volume 408. A technique for determining whether or not a conformal lattice cell can fit in the sub-volume 408 is discussed below using a specified height range. If conformal lattice cells can fit in the sub-volume 408, then the hybrid lattice structure generation engine 600 determines (at 608) a quantity of layers of conformal lattice cells to fill the sub-volume 408. In some examples, conformal lattice cells can be placed by starting from the surface 302 or 304, or alternatively, starting from the mid-surface 402.

If the hybrid lattice structure generation engine 600 determines that no conformal lattice cell can fit in a given sub-volume 408, which may be the case in the relatively small trailing end portion 410 of the volume 306, the hybrid lattice structure generation engine 600 can identify (at 610) that the given sub-volume 408 is to be filled with uniform lattice cells that are subject to trimming when appropriate.

Whether or not conformal lattice cell(s) can fit in a sub-volume 408 is dependent upon the height H relative to the specified height range (which can be specified by a user or another entity). The specified height range defines a minimum height and a maximum height of a conformal lattice cell. In other words, conformal lattice cells that have a height less than the minimum are disallowed. Additionally, the hybrid lattice structure generation engine 600 does not allow scaling of a conformal lattice cell to a height greater than the maximum height. Although reference is made to a height range, it is noted that a range can be specified for other dimensions of a lattice cell, such as width, a depth, a diameter, and so forth.

Note that in some cases, a sub-volume 408 has a height H that can fit one conformal lattice cell or a stack of multiple conformal lattice cells, but a remaining portion of the sub-volume 408 (leftover after the conformal lattice cell(s) has (have) been placed in the sub-volume 408) would not be able to fit another conformal lattice cell without violating the specified height threshold. In this case, the hybrid lattice structure generation engine 600 would fill a first part of the sub-volume 408 with conformal lattice cell(s), and fill (at 612) a remaining part of the sub-volume 408 with uniform lattice cell(s) subject to trimming.

The hybrid lattice structure generation engine 600 can further determine (at 614) orientations of the conformal lattice cells that are placed in the volume 306. Conformal lattice cells adjacent to each surface 302 or 304 can be oriented so that each such conformal lattice cell has a height that is normal to the surface 302 or 304. This allows the conformal lattice cells to be oriented normal to a primary loading direction of forces applied on the lattice structure in the volume 306, such as forces applied by a user's foot and the ground on a midsole.

The hybrid lattice structure generation engine 600 can fill the sub-volumes with conformal lattice cells and/or uniform lattice cells. In the sub-volumes filled with uniform lattice cells, the hybrid lattice structure generation engine 600 can trim the uniform lattice cells to fit within each sub-volume.

By using hybrid lattice structures according to some examples, better control of dimensions of conformal lattice cells can be achieved, by using conformal lattice cells that satisfy a specified range for a dimension (or multiple dimensions). This can avoid portions of the lattice structure with a dense arrangement of lattice cells that are too small, for example. Additionally, conformal lattice cells can be oriented to target directions, such as to be normal to the primary loading direction, which can improve the performance of the lattice structure (e.g., superior support when compressed, etc.).

Once a hybrid lattice structure is built by the hybrid lattice structure generation engine 600, the hybrid lattice structure generation engine 600 can send a representation of an object (e.g., a CAD file) to be built that includes the hybrid lattice structure to an additive manufacturing machine. The additive manufacturing machine builds the object on a layer-by-layer basis based on the representation of the object that includes the hybrid lattice structure.

The object manufactured by an additive manufacturing process applied by the additive manufacture machine includes a lattice structure that has a first region filled with conformal lattice cells of different characteristics, and a second region filled with uniform lattice cells a collection of which are trimmed.

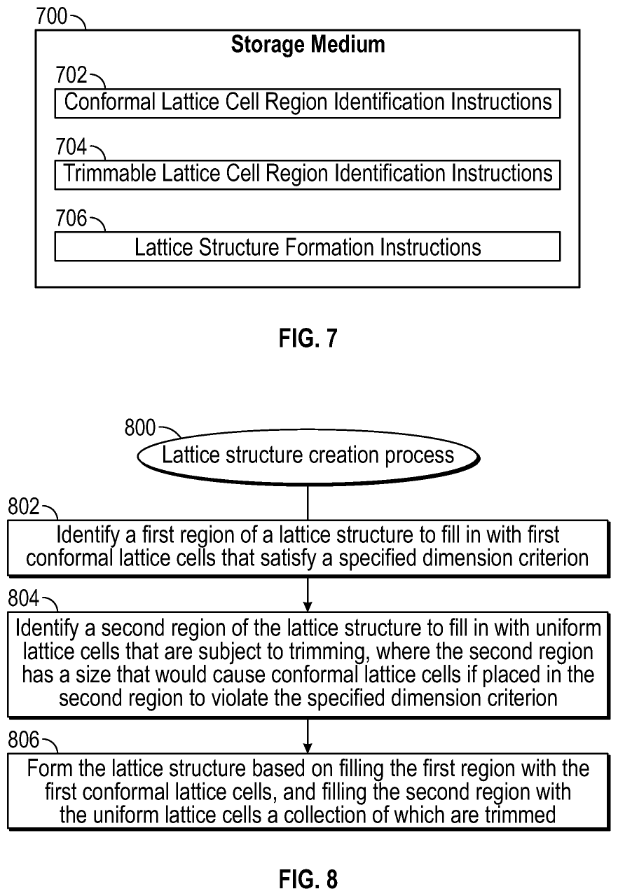

FIG. 7 is a block diagram of a non-transitory machine-readable or computer-readable storage medium 700 storing machine-readable instructions that upon execution cause a system to perform various tasks.

The machine-readable instructions include conformal lattice cell region identification instructions 702 to identify a first region of a lattice structure to fill in with conformal lattice cells.

The machine-readable instructions include trimmable lattice cell region identification instructions 704 to identify a second region of the lattice structure to fill in with lattice cells that are subject to trimming.

The machine-readable instructions include lattice structure formation instructions 706 to form the lattice structure based on filling the first region with the conformal lattice cells, and filling the second region with a collection of trimmed lattice cells.

In some examples, the identifying of the first region includes determining (e.g., at 606 in FIG. 6) that a layer of conformal lattice cells is able to fit within the first region given dimensions of the first region.

In some examples, the identifying of the first region includes determining that the layer of conformal lattice cells that is able to fit within the first region satisfies a specified dimension range.

In some examples, the identifying of the second region includes determining that a layer of conformal lattice cells that satisfies a specified dimension range is unable to fit in the second region.

FIG. 8 is a flow diagram of a process 800 of creating a lattice structure for a 3D object to be built by an additive manufacturing machine, in accordance with some examples.

The process 800 includes identifying (at 802) a first region of a lattice structure to fill in with first conformal lattice cells that satisfy a specified dimension criterion (e.g., the specified height range discussed further above).

The process 800 includes identifying (at 804) a second region of the lattice structure to fill in with lattice cells that are subject to trimming, where the second region has a size that would cause conformal lattice cells if placed in the second region to violate the specified dimension criterion.

The process 800 includes forming (at 806) the lattice structure based on filling the first region with the first conformal lattice cells, and filling the second region with the uniform lattice cells a collection of which are trimmed.

A storage medium (e.g., 700 in FIG. 7) can include any or some combination of the following: a semiconductor memory device such as a dynamic or static random access memory (a DRAM or SRAM), an erasable and programmable read-only memory (EPROM), an electrically erasable and programmable read-only memory (EEPROM) and flash memory or other type of non-volatile memory device; a magnetic disk such as a fixed, floppy and removable disk; another magnetic medium including tape; an optical medium such as a compact disk (CD) or a digital video disk (DVD); or another type of storage device. Note that the instructions discussed above can be provided on one computer-readable or machine-readable storage medium, or alternatively, can be provided on multiple computer-readable or machine-readable storage media distributed in a large system having possibly plural nodes. Such computer-readable or machine-readable storage medium or media is (are) considered to be part of an article (or article of manufacture). An article or article of manufacture can refer to any manufactured single component or multiple components. The storage medium or media can be located either in the machine running the machine-readable instructions, or located at a remote site from which machine-readable instructions can be downloaded over a network for execution.

In the foregoing description, numerous details are set forth to provide an understanding of the subject disclosed herein. However, implementations may be practiced without some of these details. Other implementations may include modifications and variations from the details discussed above. It is intended that the appended claims cover such modifications and variations.

What is claimed is:

1. An object manufactured by an additive manufacturing process, comprising:
a lattice structure comprising:
a first region filled with conformal lattice cells of different characteristics; and
a second region filled with uniform lattice cells some of which are trimmed.

2. The object of claim 1, wherein a first conformal lattice cell in the first region has a different size, shape, or orientation than a second conformal lattice cell in the first region.

3. The object of claim 2, wherein the first conformal lattice cell has a same arrangement of beams as the second conformal lattice cell, and wherein the arrangement of beams of the first conformal lattice cell has the different size, shape, or orientation than the arrangement of beams of the second conformal lattice cell.

4. The object of claim 1, wherein untrimmed lattice cells of the uniform lattice cells in the second region have a same shape, a same size, and a same orientation.

5. The object of claim 1, wherein the first region of the lattice structure includes a first layer of conformal lattice cells, and the second region of the lattice structure includes a second layer of uniform lattice cells a collection of which are trimmed, wherein the first layer and the second layer are one on top of another.

6. The object of claim 5, wherein the first region of the lattice structure includes a third layer of conformal lattice cells, wherein:
the second layer is on top of a stack including the first layer and the third layer, or
the second layer is underneath the stack including the first layer and the third layer.

7. The object of claim 1, comprising a cushion that comprises the lattice structure.

8. A non-transitory machine-readable storage medium comprising instructions that upon execution cause a system to:
identify a first region of a lattice structure to fill in with conformal lattice cells;
identify a second region of the lattice structure to fill in with lattice cells that are subject to trimming; and
form the lattice structure based on filling the first region with the conformal lattice cells, and filling the second region with a collection of trimmed lattice cells.

9. The non-transitory machine-readable storage medium of claim 8, wherein the lattice cells in the second region are uniform lattice cells.

10. The non-transitory machine-readable storage medium of claim 8, wherein the lattice cells in the first region comprise a first lattice cell that has a characteristic different from a characteristic of a second lattice cell in the first region.

11. The non-transitory machine-readable storage medium of claim 10, wherein the first lattice cell and the second lattice cell has a same arrangement of interconnected beams, and wherein the arrangement of interconnected beams of the first lattice cell is deformed with respect to the arrangement of interconnected beams of the second lattice cell.

12. The non-transitory machine-readable storage medium of claim 8, wherein the instructions upon execution cause the system to:
determine dimensions of a volume in which the lattice structure is to occupy,
wherein the identifying of the first region to fill in with the conformal lattice cells and the identifying of the second region to fill in with the lattice cells that are subject to trimming are based on the determined dimensions.

13. The non-transitory machine-readable storage medium of claim 8, wherein the instructions upon execution cause the system to:
output a representation of the lattice structure to build a three-dimensional object using the lattice structure by an additive manufacturing machine.

14. A method of creating a lattice structure for a three-dimensional object to be built by an additive manufacturing machine, comprising:
identifying a first region of a lattice structure to fill in with first conformal lattice cells that satisfy a specified dimension criterion;
identifying a second region of the lattice structure to fill in with uniform lattice cells that are subject to trimming, wherein the second region has a size that would cause conformal lattice cells if placed in the second region to violate the specified dimension criterion; and
forming the lattice structure based on filling the first region with the first conformal lattice cells, and filling the second region with the uniform lattice cells a collection of which are trimmed.

15. The method of claim 14, wherein a first conformal lattice cell in the first region has a different size, shape, or orientation than a second conformal lattice cell in the first region, and wherein untrimmed lattice cells of the uniform lattice cells in the second region have a same shape, a same size, and a same orientation.
